(19) United States
(12) Patent Application Publication
(10) Pub. No.: US 2026/0296587 A1
(43) Pub. Date: Oct. 1, 2026

(54) VEHICLE

(71) Applicant: KAWASAKI MOTORS, LTD., Hyogo (JP)

(72) Inventor: Kaoru KOUCHI, Akashi-shi (JP)

(21) Appl. No.: 19/629,978

(22) Filed: Mar. 26, 2026

(30) Foreign Application Priority Data
Mar. 26, 2025 (JP) 2025-052280

(51) Int. Cl. B62J 45/42; B62J 6/026; B62J 17/04; B62J 45/41

(52) U.S. Cl. CPC B62J 45/42; B62J 6/026; B62J 17/04; B62J 45/41

(57) ABSTRACT

There is provided a vehicle including: a front cowl configured as an outer shell of the vehicle; a windshield member provided on an upper portion of the front cowl, inclining upward from a front end toward a rear side, and configured to deflect traveling wind upward; and a radar device adjacent to a lower side of the windshield member, having at least a part located rearward of the front end of the windshield member, and configured to detect an object in front. The windshield member includes a radar cover inclining upward from a front end toward the rear side to cover the radar device from a front side.

### CROSS-REFERENCE TO RELATED APPLICATIONS

This application is based on and claims priority under 35 USC 119 from Japanese Patent Application No. 2025-052280 filed on Mar. 26, 2025, the contents of which are incorporated herein by reference.

### TECHNICAL FIELD

The present disclosure relates to a vehicle including a radar device.

### BACKGROUND ART

WO2019/224961A1 discloses a straddle-type vehicle in which a radar device is disposed inside a front cowl.

### SUMMARY OF INVENTION

In WO2019/224961A1, the radar device is disposed inside the front cowl, and therefore, the front cowl is increased in size, which may reduce the degree of freedom in design.

The present disclosure provides a vehicle that is equipped with a radar device and capable of suppressing a reduction in the degree of freedom in design of a front portion.

According to an illustrative aspect of the present disclosure, a vehicle includes: a front cowl configured as an outer shell of the vehicle; a windshield member provided on an upper portion of the front cowl, inclining upward from a front end toward a rear side, and configured to deflect traveling wind upward; and a radar device adjacent to a lower side of the windshield member, having at least a part located rearward of the front end of the windshield member, and configured to detect an object in front. The windshield member includes a radar cover inclining upward from a front end toward the rear side to cover the radar device from a front side.

According to the vehicle of the present disclosure, it is possible to mount a radar device while suppressing a reduction in the degree of freedom in design of the vehicle.

### BRIEF DESCRIPTION OF DRAWINGS

FIG. 1 is a perspective view of a motorcycle according to an embodiment of the present disclosure;

FIG. 2 is a side view showing a front portion of the motorcycle;

FIG. 3 is a front view showing the front portion of the motorcycle;

FIG. 4 is a plan view showing the front portion of the motorcycle;

FIG. 5 is a cross-sectional view taken along a line V-V in FIG. 4;

FIG. 6 is a partially enlarged view showing a windshield member, a radar device, and the surrounding area;

FIG. 7 is a front view schematically showing modifications of the windshield member and the radar cover;

FIG. 8 is a front view schematically showing a modification of the windshield member; and

FIG. 9 is a front view schematically showing another modification of the windshield member.

### DESCRIPTION OF EMBODIMENTS

A motorcycle 1 serving as an example of a vehicle according to an embodiment of the present disclosure will be described with reference to the drawings. In the present specification, "front", "rear", "left", and "right" refer to the front direction, the rear direction, the left direction, and the right direction as viewed from a rider who rides the vehicle while riding on the vehicle. In the present embodiment, a left-right direction may be referred to as a width direction. The vehicle may be a tricycle, a four-wheeled buggy, or the like, in addition to the motorcycle.

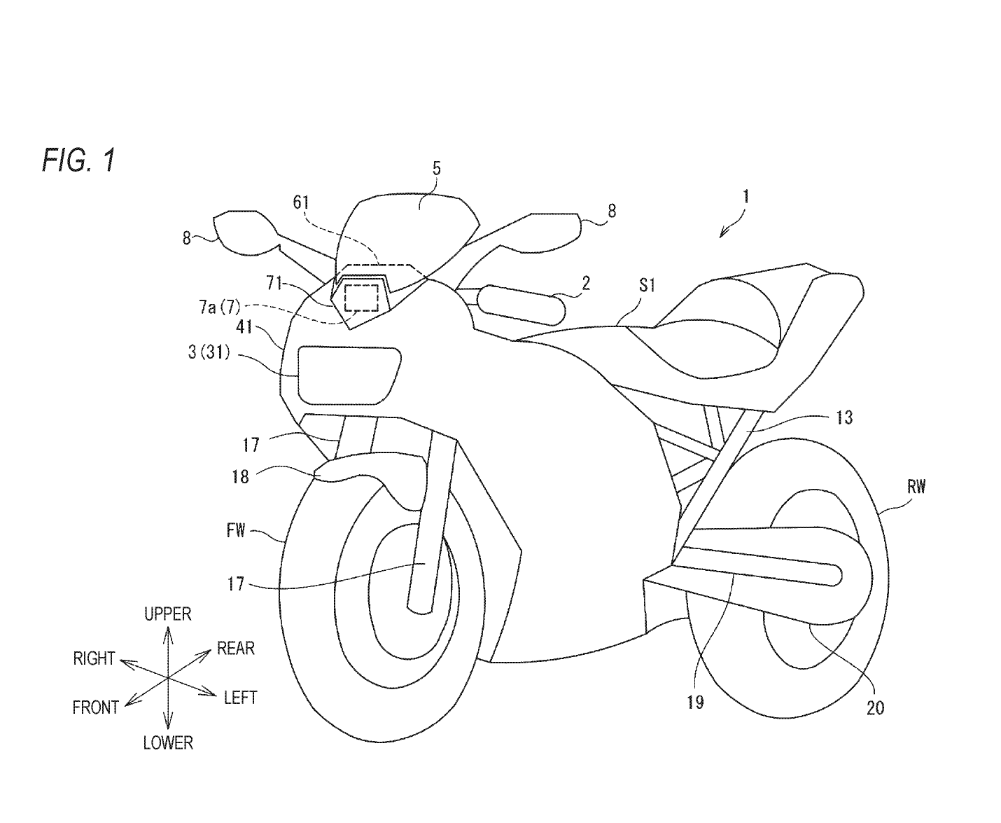

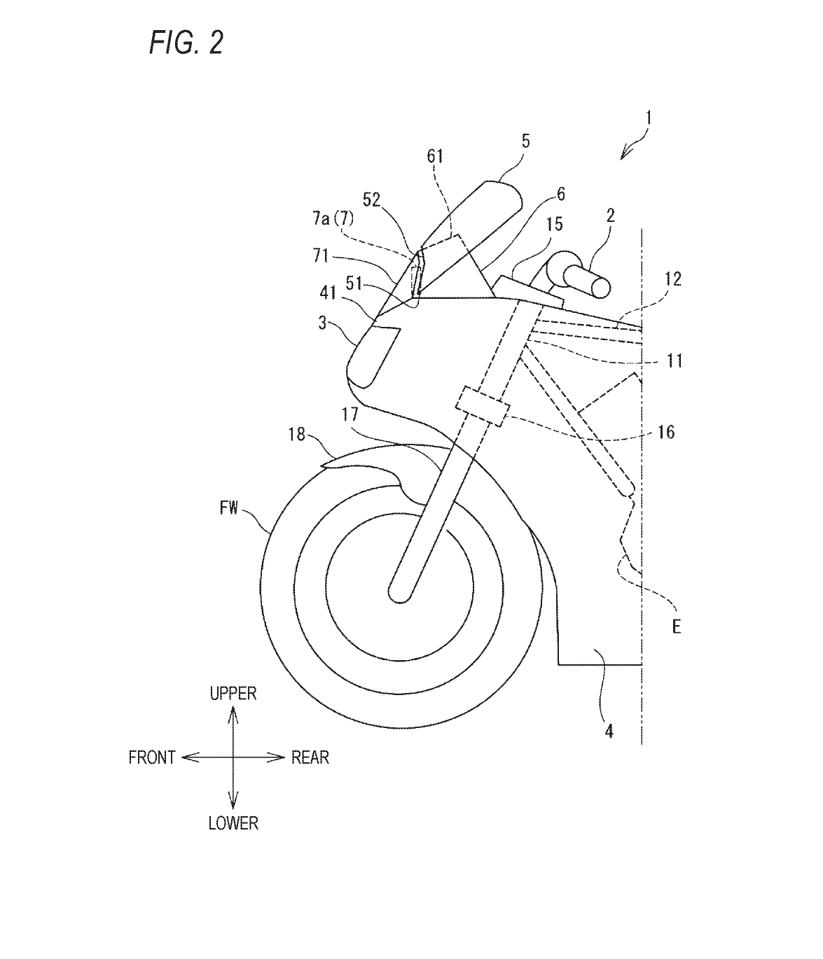

FIG. 1 is an overall perspective view of the motorcycle 1 according to an embodiment of the present disclosure. FIG. 2 is a side view showing a front portion of the motorcycle 1. When the motorcycle 1 is in a traveling state, a part of a riding space is open to the outside. Therefore, a rider riding the motorcycle 1 is exposed to a part of the traveling wind. The motorcycle 1 is provided with a windshield member 5 that deflects upward the traveling wind that is directed toward the rider.

The motorcycle 1 includes a plurality of vehicle body frames that form the skeleton of the motorcycle 1. As shown in FIG. 2, the vehicle body frames include a head pipe 11, a front frame 12, and a rear frame 13 (FIG. 1). The vehicle body frames support an engine E, which is a drive source, and a seat S1 (FIG. 1) on which a rider sits. The vehicle body frames rotatably support a front wheel FW and a rear wheel RW (FIG. 1). The vehicle body frames steerably support the front wheels FW.

The head pipe 11 extends substantially in an upper-lower direction, and a steering shaft (not shown) is inserted through the head pipe 11. An upper bracket 15 is disposed above the head pipe 11. A lower bracket 16 is disposed below the head pipe 11.

A pair of front forks 17 are attached to both left and right side portions of the upper bracket 15 and the lower bracket 16. The front wheel FW is rotatably supported at a lower end portion of the front fork 17. An upper side of the front wheel FW is covered with a front fender 18.

The front frame 12 is connected to the head pipe 11. The front frame 12 is disposed to extend rearward from the head pipe 11. The engine E is attached to the front frame 12.

As shown in FIG. 1, the rear frame 13 is connected to a rear portion of the front frame 12 (FIG. 2). A swing arm 19 is attached to a rear portion of the rear frame 13. The rear wheel RW is rotatably supported at a rear portion of the swing arm 19.

A driving force generated by the engine E is transmitted to the rear wheel RW via a drive chain 20. This allows the motorcycle 1 to travel.

As shown in FIG. 2, the upper bracket 15 supports a bar-shaped handle (hereinafter also referred to as a "bar handle") 2 extending in the width direction via a handle holder or the like. When the bar handle 2 is operated, the steering shaft, the upper bracket 15, the lower bracket 16, and the front fork 17 rotate around the axis of the head pipe 11. This rotation causes the front wheel FW to rotate about the axis of the head pipe 11, allowing a traveling direction of the motorcycle 1 to be changed.

As shown in FIG. 1, at the front portion of the motorcycle 1, a headlamp 3, a front cowl 41, a windshield 5, a display device 6 (FIG. 2), a meter visor 61, and a radar device 7 are provided. The headlamp 3 is a lighting device that illuminates an area in front of the vehicle. The front cowl 41 is configured as an outer surface of the motorcycle 1, in other words, serves as an outer shell member. The windshield 5 functions as one of windshield members that deflect upward the traveling wind that is directed toward the rider. The display device 6 displays the state of the vehicle. The meter visor 61 is located in front of the display device 6 and hides a front surface of the display device 6. The radar device 7 detects the presence or absence of an obstacle in front of the vehicle in order to assist driving of the vehicle.

In the present embodiment, the front portion of the motorcycle 1 means a portion in front of the rider when riding the motorcycle. Specifically, the front portion of the motorcycle 1 may be a portion located in front of the seat S1 or a portion located in front of the bar handle 2.

The headlamp 3 may adopt the configuration of a headlamp 3 having a known structure. The headlamp 3 of the present embodiment is a single-lens type headlamp 3. A center position in the width direction of the headlamp 3 is located at a center position in the vehicle width direction of the motorcycle 1. The headlamp 3 illuminates the front of the vehicle with light emitted from a light source. As the light source for the headlamp, an LED light source may be used, or a light source using a halogen bulb may be used. The headlamp 3 reflects the light emitted from the light source using a reflector or refracts the light using a convex lens, thereby adapting the light to serve as headlight for illuminating the area in front of the vehicle.

The headlamp 3 is accommodated in an accommodation space defined by a cowl, which will be described later. The headlamp 3 includes an outer lens that transmits light from the light source. The outer lens illuminates a front area with the transmitted light. The outer lens forms an illumination region 31 of the headlamp 3 that illuminates a front area with light. The outer lens is partially exposed from an opening formed in the front cowl 41 in a state where the headlamp 3 is accommodated in the cowl. In other words, the headlamp 3 has the illumination region 31 that is not covered by the cowl 4.

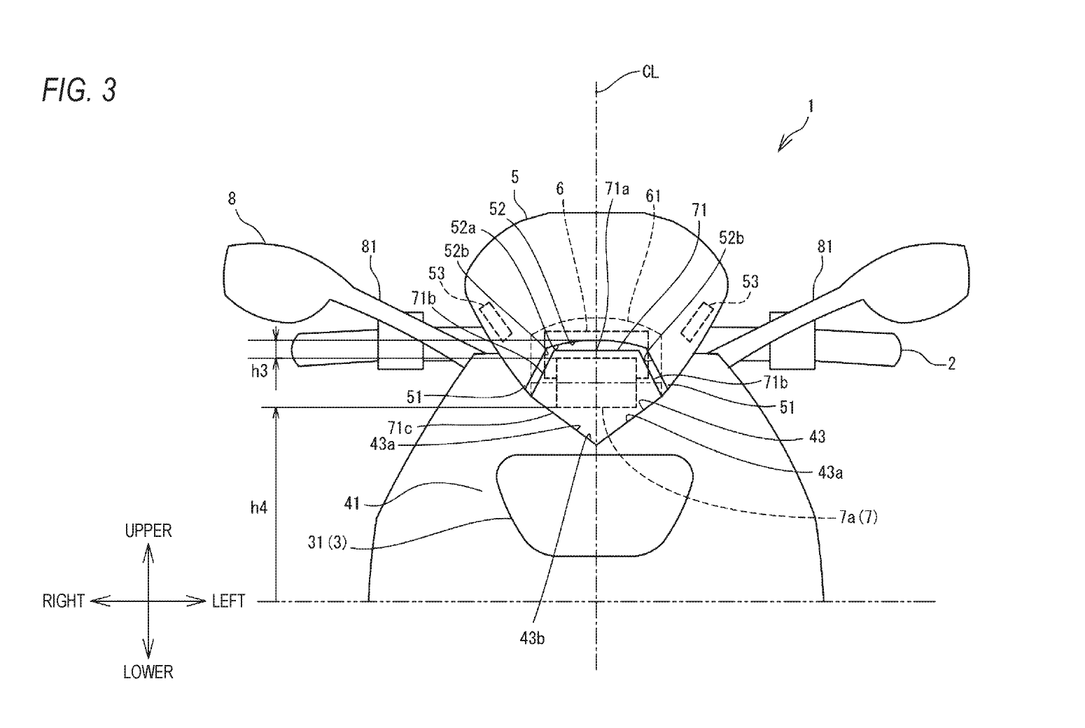

As shown in FIG. 2, in the present embodiment, the center of the headlamp 3 in the width direction is arranged to coincide with a center line CL (FIG. 3) in the width direction of the vehicle body. The headlamp 3 is disposed in front of the head pipe 11 to face the head pipe 11. The headlamp 3 is disposed in front of and below the windshield member 5. The headlamp 3 is supported by the vehicle body frame via a bracket (not shown) or the like.

The front cowl 41 is located above the front wheel FW. The front cowl 41 forms the accommodation space for accommodating the headlamp 3. The front cowl 41 is formed in a streamlined shape that gradually increases in the width direction and in the upper-lower direction from a front end to the rear. The front cowl 41 is located inward in the width direction from both ends of the bar handle 2 in the left-right direction. For example, the front cowl 41 may be provided for the purpose of reducing air resistance and protecting components of the motorcycle 1. In the present embodiment, the front cowl 41 is made of synthetic resin, and is colored by applying paint. For example, the paint may contain glittering materials made of metal particles such as aluminum flakes.

In the present embodiment, a cowl that is mainly disposed in a front surface and a front portion of the motorcycle 1 is referred to as the front cowl 41. The front portion of the motorcycle 1 is a portion in front of the bar handle 2. The front cowl 41 covers an outer side surface of the headlamp 3 in the width direction. The front cowl 41 has an opening formed therein for exposing the illumination region 31 of the headlamp 3. In other words, the front cowl 41 covers the headlamp 3 from the front, except for the illumination region 31. The front cowl 41 is supported by the vehicle body frame via a bracket (not shown) or the like.

The windshield 5 is located rearward of the front end of the front cowl 41 and is provided on an upper part of the front cowl 41. The windshield 5 is inclined upward from a front end toward the rear in a side view. The windshield 5 is implemented as a separate body from the front cowl 41. The windshield 5 functions as one of the windshield members that deflect upward the traveling wind flowing along the front cowl 41.

The windshield 5 is made of a transparent or semi-transparent material that can transmit visible light in order to ensure the field of view of the rider. The windshield 5 is implemented as a separate member from the front cowl 41. The windshield 5 protrudes upward from an upper surface of the front cowl 41. A front end 51 of the windshield 5 is located in front of the bar handle 2 and below the bar handle 2.

An upper end of the windshield 5 is located above the bar handle 2. The traveling wind is guided upward by colliding with a front surface of the windshield 5. Further, part of the traveling wind that collides with the front cowl 41 moves from the front cowl 41 toward the upper end of the windshield 5. This allows the motorcycle 1 to reduce the amount of traveling wind toward the rider.

A center position in the width direction of the windshield 5 is located at a center position in the vehicle width direction of the motorcycle 1. The windshield 5 has a cross-sectional shape cut along a horizontal cross section perpendicular to the vertical direction, and is formed in a curved plate shape with the center in the width direction protruding forward. As a result, when the traveling wind collides with the windshield 5, part of the wind is directed upward and the other part is directed outward in the width direction.

The center of the windshield 5 in the width direction is arranged to coincide with the center line CL (FIG. 3) in the width direction of the vehicle body. In the present embodiment, the windshield 5 is disposed rearward and above an upper end of the headlamp 3 at a distance.

The display device 6 may be a meter display device of a known structure. The display device 6 displays a state of the vehicle, such as a traveling speed, an engine speed, a remaining fuel level, and an abnormal state indication. In the present embodiment, the display device 6 is disposed behind a lower portion of the windshield 5 and in front of the bar handle 2. In the present embodiment, the display device 6 is disposed above and behind the upper end of the headlamp 3. The display device 6 is supported by the vehicle body frame via a support member. The display device 6 is covered above and in front by the meter visor 61.

In the present embodiment, the meter visor 61 covers the front surface of the display device 6 to hide the front surface of the display device 6. The meter visor 61 may be formed to prevent direct sunlight from reaching the display device 6. In the present embodiment, the meter visor 61 is made of a material that blocks light transmission, thereby preventing the front surface of the display device 6 from being exposed. In the present embodiment, since the meter visor 61 is made of a resin material containing a coloring pigment, transmission of light is prevented. It is preferable that the meter visor 61 is not painted with paint. In the present embodiment, the meter visor 61 is fixed to the front cowl 41. The meter visor 61 is a plate-shaped member that is inclined upward from a front end toward the rear.

The meter visor 61 is located rearward of the front end of the front cowl 41 and is provided on the upper part of the front cowl 41. The meter visor 61 is inclined upward from the front end toward the rear in a side view. The meter visor 61 is implemented as a separate body from the front cowl 41. The meter visor 61 functions as one of the windshield members that deflect upward the traveling wind flowing along the front cowl 41. The meter visor 61 is implemented by a member separate from the front cowl 41 and protrudes upward from the upper surface of the front cowl 41. An upper end of the meter visor 61 is located in front of the display device 6 and above an upper end of the display device 6. A lower end of the meter visor 61 is located in front of the display device 6 and below a lower end of the display device 6. The traveling wind is guided upward by colliding with a front surface of the meter visor 61. Further, part of the traveling wind that collides with the front cowl 41 moves from the front cowl 41 along the front surface of the meter visor 61. This allows the motorcycle 1 to reduce the amount of traveling wind toward the rider.

A front end of the meter visor 61 is located forward and below the front end of the windshield 5. A rear end of the meter visor 61 may be located rearward and above the front end of the windshield 5. In this case, the rear end of the meter visor 61 is disposed below the windshield 5.

A center position in the width direction of the meter visor 61 is located at a center position in the vehicle width direction of the vehicle. The meter visor 61 has a cross-sectional shape cut along a horizontal cross section perpendicular to the vertical direction, and is formed in a curved plate shape with the center in the width direction protruding forward. As a result, when the traveling wind collides with the meter visor 61, part of the wind is directed upward and the other part is directed outward in the width direction. The center of the meter visor 61 in the width direction is arranged to coincide with the center line CL (FIG. 3) in the width direction of the vehicle body. In the present embodiment, the meter visor 61 is disposed rearward and above an upper end of the headlamp 3 at a distance.

As shown in FIG. 1, the radar device 7 detects the presence or absence of an obstacle in front of the vehicle in order to assist driving of the vehicle. The radar device 7 transmits an electromagnetic radar wave implemented by an electromagnetic wave forward. The radar device 7 receives radar waves reflected by an object in front of the vehicle. The radar device 7 compares the transmitted and received radar waves to detect a direction of the object in front of the vehicle and a distance to the object. A detection results of the radar device 7 is output to a control device of the vehicle. For example, the control device can notify the rider of information about an object in front based on the presence or absence of the object and a distance to the object, or activate the brake to assist in preventing a collision with the object. In addition, the control device may execute, based on the detection result of the radar device 7, tracking control to follow a moving object traveling ahead at a traveling speed specified by the user while maintaining a distance from the moving object to be within a predetermined range or greater. The radar device 7 is provided for transmitting and receiving radar waves. The radar device 7 is disposed such that a transmission-reception surface 7a faces forward.

The radar device 7 is disposed at the center in the width direction of the motorcycle 1. More specifically, the radar device 7 is disposed between the pair of left and right front forks 17. The radar device 7 is disposed in the width direction between a pair of left and right windshield stays 53 (FIG. 3) that support the windshield 5. In other words, the transmission-reception surface 7a is disposed between the pair of left and right windshield stays 53 (FIG. 3) in the front view. By disposing the radar device 7 at the center in the width direction, the radar device 7 can detect both the left and right sides of the motorcycle 1 equally.

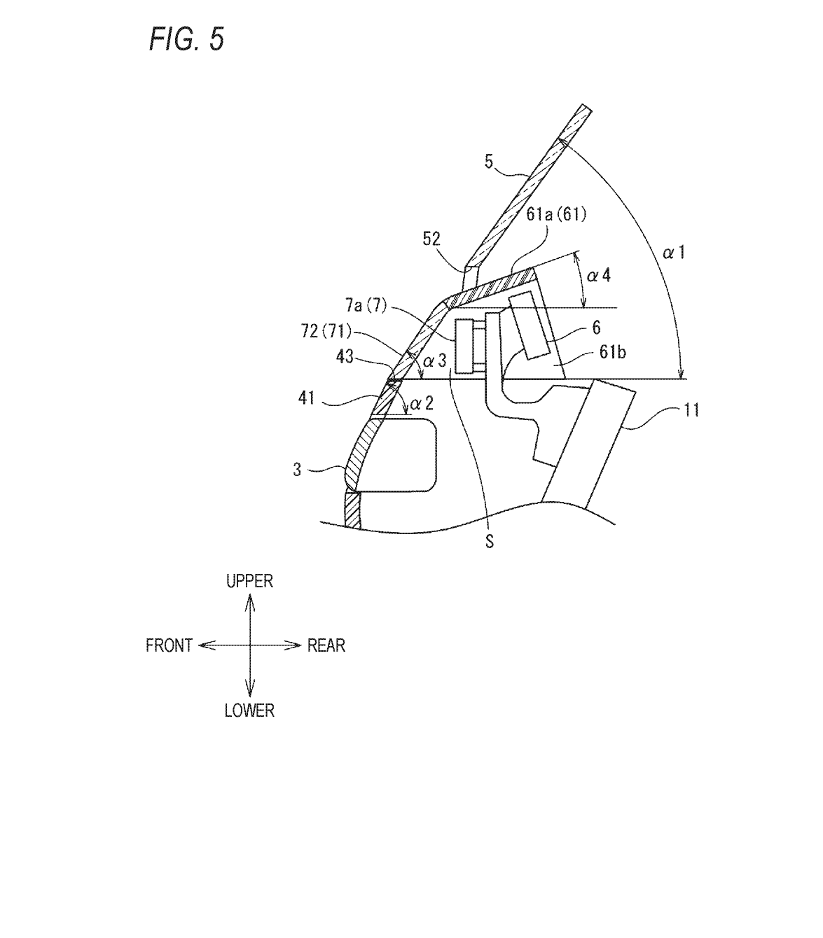

In the present embodiment, the radar device 7 is disposed adjacent to a lower side of the meter visor 61, which is one of the windshield members. In other words, the radar device 7 is disposed behind and adjacent to a windshield portion of the meter visor 61. The radar device 7 is disposed behind an exposed portion of the meter visor 61 that is located below a lower end 51 of the windshield 5 and is exposed forward. The transmission-reception surface 7a of the radar device 7 is disposed behind and adjacent to the exposed portion. The exposed portion of the meter visor 61 that is exposed from the windshield 5 serves as a radar cover 71 that covers the transmission-reception surface 7a of the radar device 7 from the front. The exposed portion is inclined upward from a front end toward the rear. In the present embodiment, this exposed portion is referred to as the radar cover 71. In other words, the radar device 7 is accommodated in a radar accommodation space S (FIG. 5) defined behind the radar cover 71. The meter visor 61 is preferably made of different materials for the radar cover 71, which is the exposed portion, and the remaining portion. This allows the radar cover 71 to be made using a material with excellent radar transmittance.

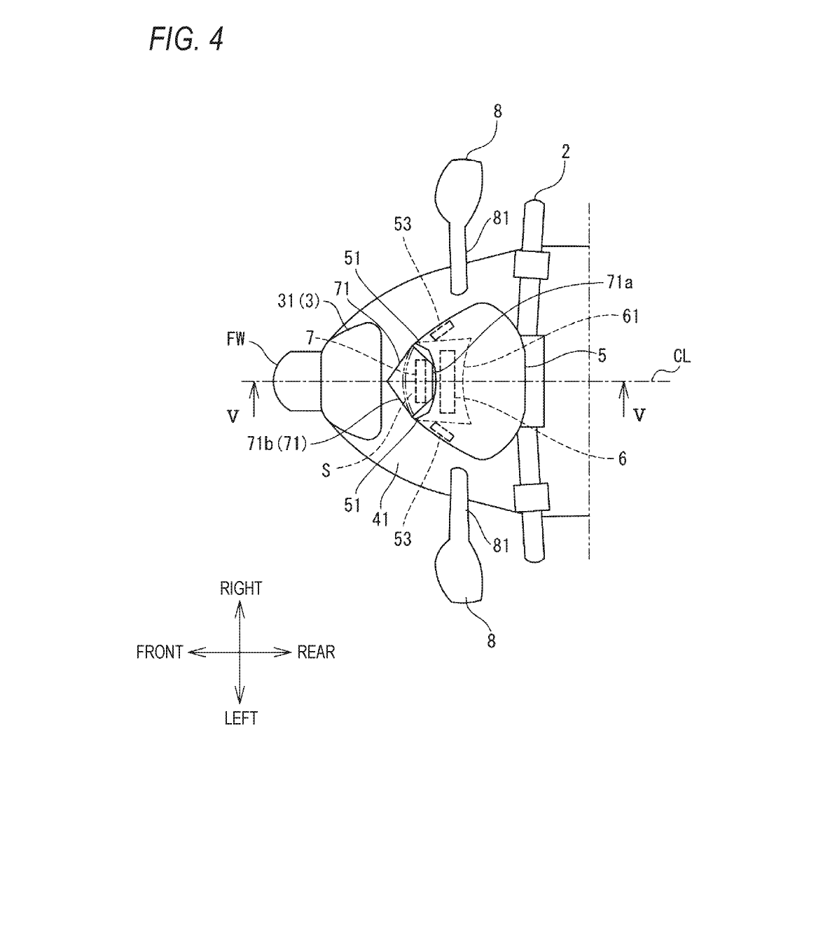

FIG. 3 is a front view showing the front portion of the motorcycle 1. FIG. 4 is a plan view showing the front portion of the motorcycle 1. As shown in FIG. 3, the transmission-reception surface 7a of the radar is formed in a rectangular shape in a front view. In the present embodiment, the center of the transmission-reception surface 7a in the width direction coincides with the center of the radar device 7 in the width direction. In the present embodiment, the transmission-reception surface 7a of the radar device 7 is disposed at the center in the width direction of the motorcycle 1. The radar cover 71 covers the entire transmission-reception surface 7a from the front. Therefore, a lower end of the radar cover 71 extends below a lower end position of the transmission-reception surface 7a. Similarly, an upper end of the radar cover 71 extends above an upper end position of the transmission-reception surface 7a. Both ends of the radar cover 71 in the width direction extend outward in the width direction beyond both end positions of the transmission-reception surface 7a in the width direction.

The radar cover 71 and the transmission-reception surface 7a of the radar device 7 are disposed relatively high in the front portion of the motorcycle 1. This reduces the effect on the shape of the front end portion of the motorcycle 1 caused by the mounting of the radar device 7. In the present embodiment, the transmission-reception surface 7a of the radar device 7 is disposed above and spaced apart from the upper end of the headlamp 3. In the front view, the transmission-reception surface 7a of the radar device 7 is disposed above and spaced apart from the illumination region 31 of the headlamp 3. An upper end of the transmission-reception surface 7a of the radar device 7 is disposed adjacent to a lower end of the windshield 5. More specifically, the upper end of the transmission-reception surface 7a is disposed at a position adjacent to the central portion in the width direction of the windshield 5. In a vertical cross section passing through the center in the width direction and perpendicular to the width direction, the upper end of the transmission-reception surface 7a of the radar device 7 is disposed at a position higher than an upper end of the front cowl 41. In the front view, a lower end of the transmission-reception surface 7a is disposed at a position above and spaced apart from the front cowl 41. It is preferable that the lower end of the transmission-reception surface 7a is disposed at a position above and spaced apart from the front cowl 41 in the side view (FIG. 2).

As shown in FIG. 2, the transmission-reception surface 7a of the radar device 7 is located rearward of the front axle. The transmission-reception surface 7a may be disposed rearward of a rear end portion of the headlamp 3. The upper end of the transmission-reception surface 7a of the radar device 7 is disposed at a position close to the lower end of the windshield 5. The transmission-reception surface 7a of the radar device 7 is preferably disposed in front of the lower end of the windshield 5.

A rear end of the radar device 7 is disposed rearward of the lower end of the windshield 5. The rear end of the radar device 7 is disposed rearward of a rear end of the headlamp 3 and in front of a front end of the display device 6. The radar device 7 is configured such that radar waves transmitted and received from the transmission-reception surface 7a pass through the radar cover 71. In other words, the wavelength of the radar wave is set to a length that prevents the radar wave from passing through the windshield 5 above the radar cover 71 or the front cowl 41 below the radar cover 71, while allowing the radar wave to pass through the transmission-reception surface 7a.

In the vertical cross section, it is preferable that the lower end of the transmission-reception surface 7a of the radar device 7 is disposed at a position higher than the upper end of the front cowl 41. The upper end of the transmission-reception surface 7a is preferably disposed above a lower end of the head pipe 11. More preferably, it is preferable that the lower end of the transmission-reception surface 7a is disposed above the lower end of the head pipe 11. The upper end of the transmission-reception surface 7a is preferably disposed above an upper end of the head pipe 11.

The radar cover 71 is formed in an inclined shape such that an upper portion thereof smoothly connects to the lower portion of the windshield 5. Specifically, the upper end of the radar cover 71 and the lower end of the windshield 5 are disposed close to each other in the upper-lower direction. An inclination angle of the radar cover 71 and an inclination angle of the windshield 5 are configured to be flush with or substantially parallel to each other. Accordingly, the traveling wind flowing along the radar cover 71 can be easily guided to the windshield 5.

A portion of the front cowl 41 adjacent to a lower portion of the radar cover 71 is formed in an inclined shape that smoothly connects the portion to the lower portion of the radar cover 71. Specifically, the lower end of the radar cover 71 and the adjacent portion of the front cowl 41 are disposed close to each other in the upper-lower direction. The inclination angle of the radar cover 71 and an inclination angle of the front cowl 41 are configured to be flush with or substantially parallel to each other. Accordingly, the traveling wind flowing along the front cowl 41 can be easily guided to the radar cover 71.

As shown in FIG. 3, the front cowl 41 has, at the center in the width direction, a cowl recessed portion 43 whose upper portion is recessed downward in a V shape. In other words, the front cowl 41 has an upper opening formed by a cowl recessed portion 43 that opens forward. In the plan view, the upper opening is formed in a shape in which the dimension in the width direction decreases toward the front (FIG. 4). Further, in the front view, the upper opening is formed in a shape in which the dimension in the width direction decreases toward the front. The upper opening of the front cowl 41 is closed by a member including the meter visor 61. The front cowl 41 may be divided into a main body member that covers the headlamp 3 and a closing member that closes between the main body member and the meter visor 61. In this case, the main body member is a colored painted member, and the closing member is an unpainted member containing a color pigment. The closing member may be formed integrally with a part of the meter visor 61. In this case, it is preferable that the closing member is formed separately from the radar cover 71 described above.

The radar cover 71 closes the upper opening of the front cowl 41 from the front. The radar cover 71 is preferably provided detachably to the front cowl 41. The cowl recessed portion 43 opens forward along the shape of the radar cover 71. In other words, the upper opening formed by the cowl recessed portion 43 is shaped such that the transmission-reception surface 7a of the radar device 7 is located therein when viewed from the front. In other words, the transmission-reception surface 7a is located below an upper end of the upper opening and above a lower end of the upper opening. More specifically, the cowl recessed portion 43 is formed in a V shape by a pair of left and right oblique side portions 43a extending obliquely upward and rearward from the center in the width direction toward the outside. The pair of left and right oblique side portions 43a have a shape complementary to the shape of the lower portion (lower side portion 71c) of the radar cover 71 described later.

In the present embodiment, the radar cover 71 is formed in a pentagonal shape in the front view of the vehicle. Specifically, the outer shape includes an upper side portion 71a extending in the vehicle width direction, a pair of side portions 71b extending downward from both sides of the upper side portion 71a in the width direction, and the lower side portion 71c extending in the vehicle width direction by connecting lower ends of the pair of side portions 71b and bending downward in a V shape. A length in the width direction of the upper side portion 71a is set to correspond to a length in the width direction of the transmission-reception surface 7a of the radar device 7. A length in the upper-lower direction of the pair of side portions 71b is set to correspond to a length in the upper-lower direction of the transmission-reception surface 7a of the radar device 7. The pair of side portions 71b are inclined outward in the vehicle width direction as they extend downward. As described above, the center position in the width direction of the lower side portion 71c is located below an outer end in the width direction. As a result, even if the radar waves are radiated from the transmission-reception surface 7a while spreading in the width direction and the upper-lower direction, the radar waves pass through the radar cover 71 and are prevented from passing through anything other than the radar cover 71.

As illustrated in FIG. 4, in the present embodiment, the radar cover 71 is curved such that a horizontal cross-sectional shape extending perpendicularly to the plumb line is convex forward. In other words, an intermediate portion in the width direction of the radar cover 71 protrudes forward compared to both end portions in the width direction. In the present embodiment, the upper side portion 71a of the radar cover 71 is located above the lower side portion 71c of the radar cover that is in contact with the front cowl 41. Specifically, the radar cover 71 has a horizontal cross section that is formed in a forwardly convex arc shape (cross section shown by the two-dot chain line in FIG. 4). The shape of the horizontal cross section of the radar cover 71 may be U-shaped as long as it is forwardly convex, instead of being arc-shaped. If the radius of curvature of the bent portion is large, it may be formed in a V-shape or a channel shape (groove shape).

The windshield 5 is formed in a substantially arc shape protruding forward in a plan view such that the dimension in the width direction increases from the front end 51 toward the rear.

As illustrated in FIG. 3, a windshield recessed portion 52 formed by recessing a lower edge of the windshield 5 upward is formed at the center in the width direction of the front end 51 of the windshield 5. The windshield recessed portion 52 is recessed to conform to the shape of the upper portion of the radar cover 71. More specifically, the windshield recessed portion 52 includes an arc portion 52a located at the center in the width direction and extending in the width direction in an arc shape, and a pair of left and right inclined portions 52b inclined downward toward the front from both side portions in the width direction of the arc portion 52a. The arc portion 52a and the pair of left and right inclined portions 52b have shapes that are substantially complementary to the shape of the upper side portion 71a of the radar cover 71. Specifically, the windshield recessed portion 52 is formed in a shape that follows the outer shape formed by the upper side portion 71a and the pair of side portions 71b of the radar cover 71. In the present embodiment, in the front view, a lower end portion of the windshield 5 is disposed above and spaced apart from an upper end portion of the radar cover 71. By forming the windshield recessed portion 52 in this way, it is possible to prevent interference of radar waves with the windshield 5 and to dispose the radar cover 71 and the transmission-reception surface 7a at a high position.

As illustrated in FIG. 4, the pair of left and right windshield stays 53 are provided at the lower end portion of the windshield 5 and spaced apart in the width direction for attaching the windshield 5 to the vehicle body. Each windshield stay 53 is supported by the vehicle body via a bracket or the like. Since the windshield 5 is formed in an arc shape in the plan view, the windshield stay 53 is located rearward of the front end 51 of the windshield 5. As a result, the space S for disposing the radar device 7 is provided between the windshield stays 53 and in a region forward of the windshield stays 53. The radar cover 71 is located below the windshield stay 53.

The motorcycle 1 is provided with a pair of left and right mirrors 8 for checking the rear. In the present embodiment, the mirror 8 is disposed between the headlamp 3 and the bar handle 2 in a front-rear direction of the vehicle body, and is fixed to the front cowl 41 via a mirror stay 81. The radar cover 71 is disposed on the inner side of the mirror stay 81 in the width direction. The upper end of the radar cover 71 is located above a base end of the mirror stay 81 (FIG. 3).

FIG. 5 is a cross-sectional view taken along a line V-V in FIG. 4. In a vertical cross section passing through the center in the width direction and perpendicular to the width direction, a first inclination angle α1, which is an inclination angle of the windshield 5 with respect to the horizontal plane, is formed to substantially coincide with a second inclination angle α2, which is an inclination angle of the front cowl 41 with respect to the horizontal plane. A third inclination angle α3, which is an inclination angle of the radar cover 71 with respect to the horizontal plane in the vertical cross section, is formed to substantially coincide with the first inclination angle α1 and the second inclination angle α2. The first inclination angle α1 may be configured to decrease toward the rear. In this case, the third inclination angle α3 is formed to be larger than the first inclination angle α1 on the rear side. This makes it easier to arrange the radar device 7 behind the radar cover 71. In addition, it is preferable that the windshield 5 is formed at an inclination angle along a line extending rearward from the radar cover 71. Accordingly, it is possible to prevent the traveling wind flowing along the radar cover 71 from being deflected and allows it to be guided to the windshield 5.

As described above, in the present embodiment, the meter visor 61 has a covered portion that is covered by the windshield 5 in addition to the radar cover 71 that is exposed from the windshield. The covered portion of the meter visor 61 includes an upper surface portion 61a that covers the upper side of the display device 6 and extends in the width direction, and side surface portions 61b that extend downward from both side portions of the upper surface portion 61a and cover side portions of the display device 6. In the present embodiment, a fourth inclination angle α4, which is an inclination angle of the covered portion of the meter visor 61 with respect to the horizontal plane in the vertical cross section, is set to be smaller than the third inclination angle α3.

The radar device 7 is disposed behind and above the headlamp 3. The radar device 7 is disposed in front of the display device 6. The transmission-reception surface 7a of the radar device 7 is adjacent to the lower end 51 (FIG. 3) which is a front end of the windshield 5. At least a part of the radar device 7 is disposed behind the front end of the windshield 5. The accommodation space S for arranging the radar device 7 is formed between the front end of the windshield 5 and the display device 6.

The radar device 7 is disposed above the headlamp 3. In other words, the transmission-reception surface 7a is disposed above and spaced apart from the headlamp 3. The transmission-reception surface 7a is preferably disposed above and spaced apart from the illumination region 31 of the headlamp 3. A separation distance between an upper end of the illumination region 31 of the headlamp 3 and the lower end of the transmission-reception surface 7a may be set to, for example, 20 mm or more, preferably 40 mm or more. For example, a separation distance between a front end of the front cowl and the lower end of the transmission-reception surface 7a may be set to, for example, 40 mm or more, preferably 80 mm or more.

A part of the front cowl 41 is interposed between the radar device 7 and the headlamp 3. In other words, a part of the front cowl 41 is interposed between the radar cover and the headlamp. The radar device 7 is disposed at a position that does not overlap the front cowl 41 in a front view, in other words, above the front cowl. In the vertical cross section, a separation distance between the upper end of the front cowl and the lower end of the transmission-reception surface 7a may be set to, for example, 20 mm or more, preferably 40 mm or more.

The transmission-reception surface 7a is disposed adjacent to the front end 51 of the windshield 5. More specifically, a distance h3 by which an upper edge of the transmission-reception surface 7a is separated downward from the front end 51 of the windshield 5 is set to within 40 mm, preferably within 20 mm.

In the present embodiment, a height h4 from a traveling road surface to the lower end of the transmission-reception surface 7a is preferably set to 1000 mm or more, for example, 1200 mm. The transmission-reception surface 7a may be disposed at a position lower than the bar handle 2.

In the present embodiment, the meter visor 61 is implemented by a member forming the radar cover 71 and a member forming at least an upper portion of the radar cover 71 excluding the radar cover 71. The member forming the radar cover 71 is preferably formed in a shape and made of a material that is more transparent to radar waves than the remaining members of the meter visor 61. Specifically, the radar cover 71 is formed in a shape that is thinner than the remaining portion of the meter visor 61, has less unevenness in thickness, and has a larger radius of curvature. For example, the thickness of the radar cover 71 is preferably set to be uniform. In addition, it is preferable that the radar cover 71 has a smaller content of impurities, for example, carbon fibers for increasing strength, than the remaining portion of the meter visor 61.

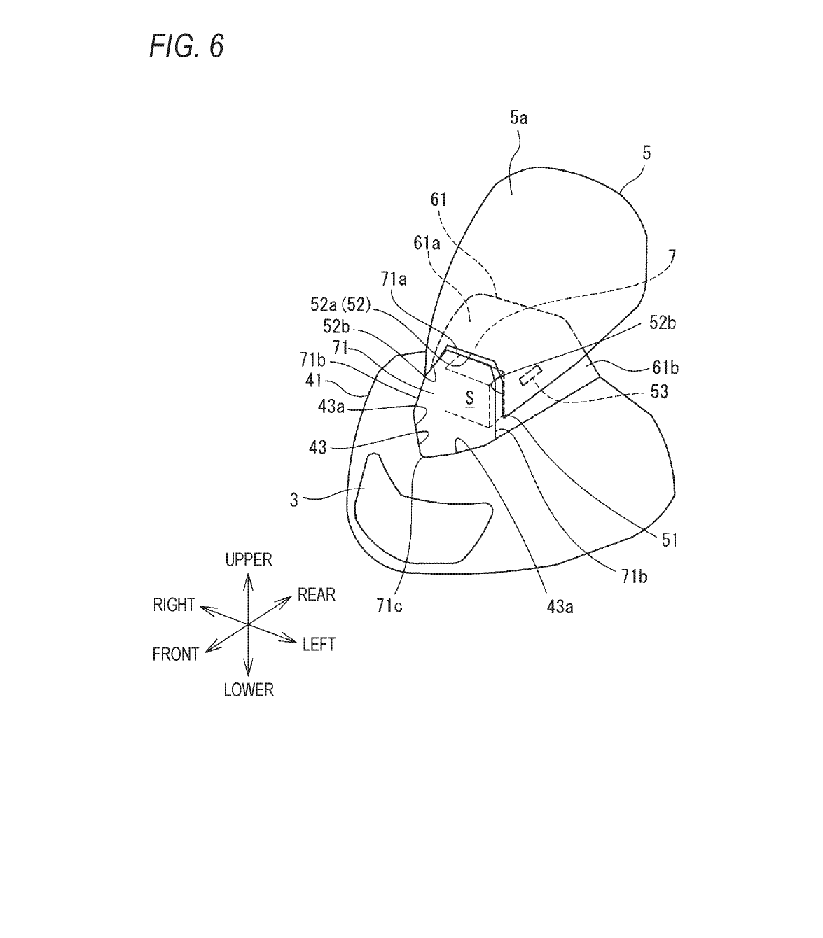

As described above, as illustrated in FIG. 6, the radar cover 71 is a part that covers the transmission-reception surface 7a from the front, and is formed in a circular arc shape whose horizontal cross section is convex forward. The radar cover 71 has a fan shape in a front view, and is formed such that the dimension in the width direction increases from a front end toward a rear end. The radar cover 71 extends obliquely upward from the front end toward the rear along the windshield 5.

The radar cover 71 has the front end formed in a substantially V-shape and the rear end formed in a substantially arc shape. The front end has a shape complementary to the cowl recessed portion 43 of the front cowl 41. The rear end has a shape complementary to the windshield recessed portion 52 of the windshield 5. The radar cover 71 is disposed to be located between the cowl recessed portion 43 and the windshield recessed portion 52.

As described above, the radar cover 71 has the lower side portion 71c including the pair of left and right oblique side portions extending obliquely upward and rearward from the center in the width direction toward the outside, the pair of left and right side portions 71b inclined rearward and outward in the width direction from an upper end of the lower side portion 71c toward the upper side, and the upper side portion 71a connecting the pair of left and right side portions 71b and extending in the width direction in an arc shape.

The transmission-reception surface 7a is covered with only the radar cover 71 from the front. In other words, the windshield 5 and/or the front cowl 41 are not disposed in front of the transmission-reception surface 7a of the radar device 7. In other words, the windshield 5 and the front cowl 41 are disposed to avoid the radar cover 71.

The radar cover 71 is formed such that there is little or no step due to a difference in curvature between the radar cover 71 and the windshield 5 and the front cowl 41 adjacent thereto above and below. The radar cover 71 is set such that the curvature of the upper portion is smaller than that of the lower portion. The curvature of the radar cover 71 is formed to gradually decrease from the lower portion toward the upper portion. The curvature of the rear end of the radar cover 71 is formed to substantially match the curvature of the windshield 5. The curvature of the front end of the radar cover 71 is formed to substantially match the curvature of the front cowl 41. The radar cover 71 is set to have a smaller curvature at the rear portion where the transmission-reception surface 7a is disposed than at the front portion. Accordingly, the adverse effects of radar waves passing through the radar cover 71 can be reduced. Similarly, when the horizontal cross section of the radar cover 71 is formed in a curved shape, the rear portion where the transmission-reception surface 7a is set to have a smaller curvature than the front portion. In other words, the circumferential length of the upper portion of the radar cover 71 in the width direction is smaller than the circumferential length of the lower portion of the radar cover 71 in the width direction. Accordingly, the adverse effects of radar waves passing through the radar cover 71 can be reduced. In addition, since the radar cover 71 is formed in a curved shape, a part of the traveling wind can be guided to the outside in the width direction, and the traveling resistance can be reduced.

The radar cover 71 covers the transmission-reception surface 7a. In this case, the radar device 7 is disposed below and adjacent to the rear of the radar cover 71 which is the windshield member 5. Accordingly, the accommodation space S for disposing the radar device 7 can be easily secured, and a decrease in the degree of freedom in design of the front part of the vehicle can be reduced.

The radar cover 71 is disposed at a relatively high position. An object detection function by the radar can be enhanced. The radar cover 71 is disposed rearward and above a front end of the front cowl 41. Accordingly, it is possible to reduce the amount of protrusion of the radar cover 71 from an extension line of the shape of the front cowl 41 having a streamlined shape, and to prevent an increase in air resistance.

The horizontal cross section of the radar cover 71 is formed to have a forward convex shape, so that the traveling wind can be guided not only forward but also outward in the width direction. Accordingly, the traveling wind toward the rider can be reduced, and the traveling resistance can be reduced. Further, by forming the radar cover in an arc shape, it is possible to prevent interference with radar waves and also to prevent the radar cover 71 from being conspicuous.

If an inclined surface of the radar cover 71 is formed larger than an inclined surface of the front cowl 41, it is easy to ensure the accommodation space S in which the transmission-reception surface 7a is disposed. By covering the transmission-reception surface 7a with a meter visor 61 for covering the front of the display device 6, the radar device 7 can be easily hidden, and the radar device 7 can be prevented from being conspicuous.

It is preferable that the radar cover 71 and the remaining portion of the meter visor 61 are detachable. This allows access to the radar device 7 by removing the radar cover 71. Therefore, it is not necessary to remove the entire meter visor 61 from the cowl, which makes it easier to perform maintenance on the radar device 7.

The radar cover 71 is made of a material or has a shape that is more transparent to radar waves than the remaining portion of the meter visor 61, so that it is possible to prevent interference with radar waves and to enhance the object detection function.

In the present embodiment, the configuration in which the windshield 5 is fixed has been described. Alternatively, the windshield 5 may be displaceable in the upper-lower direction without being fixed. In this case, it is preferable that the radar cover 71 is disposed to be exposed from the windshield 5 when the windshield 5 is positioned at the lowest end. Accordingly, even when the windshield 5 is displaced upward, the windshield 5 can be prevented from blocking the radar cover 71, and the object detection function by the radar can be easily maintained.

In the present embodiment, the lower end of the windshield 5 is formed in a recessed shape that avoids overlapping with the radar cover 71. By arranging the stay that supports the windshield in the recessed portion, it is easy to support the lower end of the windshield. Accordingly, the support rigidity of the windshield can be increased. Further, by arranging the windshield 5 so that it wraps around to a position lower than the upper end of the radar cover 71, the meter visor 61 can be made less conspicuous, and the impact of the meter visor 61 on the exterior can be reduced.

In the present embodiment, when viewed from the front, a gap is formed in the upper-lower direction between the upper end of the radar cover 71 and the lower end of the windshield 5. A part of the traveling wind flowing along the radar cover 71 can be guided toward the rider. By guiding a part of the traveling wind toward the rider in this manner, the difference in traveling speed, in other words, the pressure difference between an area around the rider and an area outside the rider when viewed from the front of the motorcycle 1 can be reduced. Accordingly, it is possible to easily reduce the load applied to the rider during high-speed traveling.

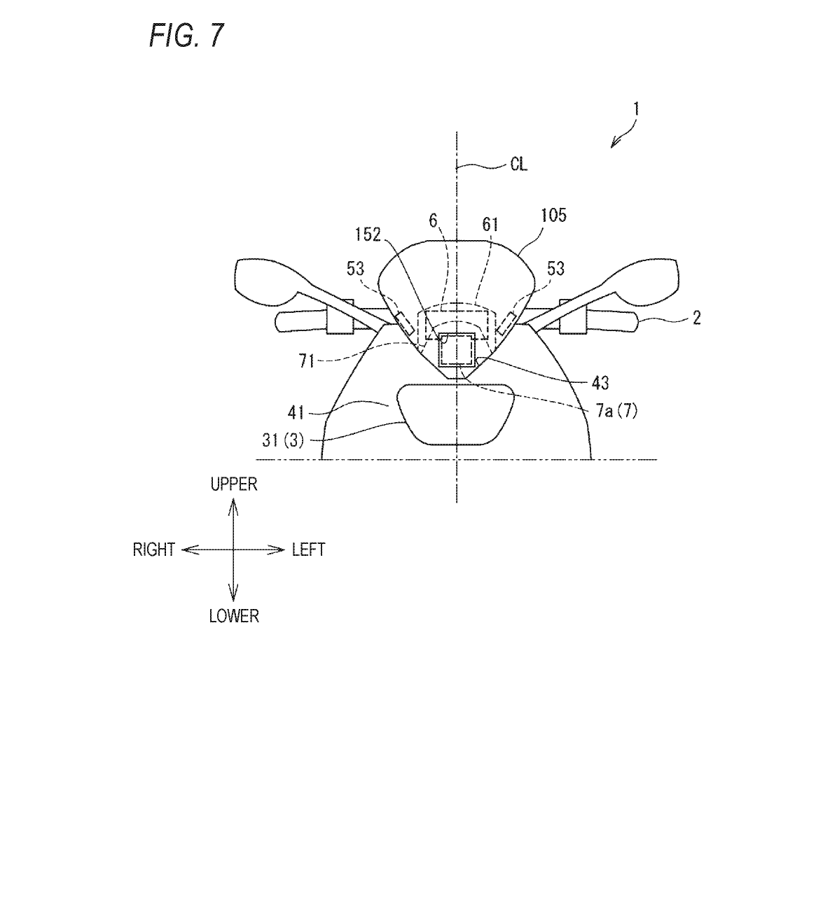

FIG. 7 is a front view showing a motorcycle according to a modification. In the motorcycle according to the modification, the radar cover 71 is covered with a windshield 105 from the front. In this case, in the front view, the windshield 5 is formed to avoid the transmission-reception surface 7a of the radar device 7 in the radar cover 71. The windshield 5 is formed with an opening 152 penetrating in the front-rear direction and corresponding to the transmission-reception surface 7a. This makes it possible to prevent the radar wave transmitted through the radar cover 71 from being transmitted through the windshield 5.

In the motorcycle according to the modification, the transmission-reception surface 7a is covered with the radar cover 71 as in the embodiment. Since the windshield 5 avoids the transmission-reception surface 7a, there is no member other than the radar cover 71 through which radar waves pass. In this case, the radar device 7 is disposed below and adjacent to the rear of the meter visor which is the windshield member 5. Accordingly, the accommodation space S for disposing the radar device 7 can be easily secured, and a decrease in the degree of freedom in design of the front part of the vehicle can be reduced.

Even in the motorcycle according to the modification, the same effect can be obtained by adopting the configuration according to the first embodiment. In addition, in the motorcycle according to the modification, a region where the meter visor 61 is covered by the windshield 5 is large, the meter visor 61 can be made less conspicuous, and the appearance can be easily improved.

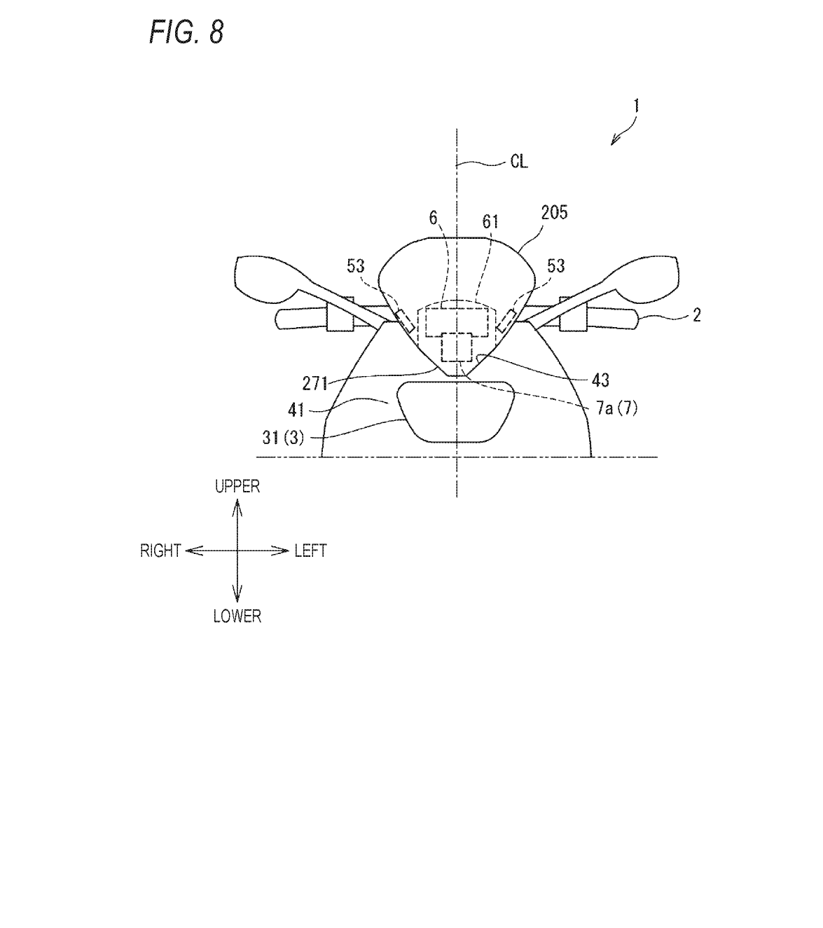

FIG. 8 is a front view showing a motorcycle according to another modification. The windshield member forming the radar cover may be other than the meter visor 61. In the motorcycle 1 according to the other modification, the radar cover 71 is implemented by a part of the windshield 5, which is the windshield member. The lower part of the windshield 5 of the motorcycle 1 according to the modification covers the transmission-reception surface 7a. In this case, no other members such as a meter visor are interposed between the windshield 5 and the transmission-reception surface 7a. In this case, the radar device 7 is disposed below and adjacent to the rear of the windshield 5 which is the windshield member 5. Accordingly, the accommodation space S for disposing the radar device 7 can be easily secured, and a decrease in the degree of freedom in design of the front part of the vehicle can be reduced.

Even in the motorcycle according to the other modification, the same effect can be obtained by adopting the configuration according to the embodiment. Further, in the motorcycle 1 according to the other modification, the number of components can be reduced by omitting the meter visor. A lower portion of a windshield 205 may be formed to be transparent, similar to an upper portion of the windshield 205. In order to make the radar device 7 and the display device 6 less visible, the lower portion of the windshield 205 may be set to have lower light transmittance than that of the upper portion. Similarly to the radar cover 71 described above, the lower portion of the windshield 205 may be formed in a shape that is more transparent to radar waves compared to the remaining shield portion.

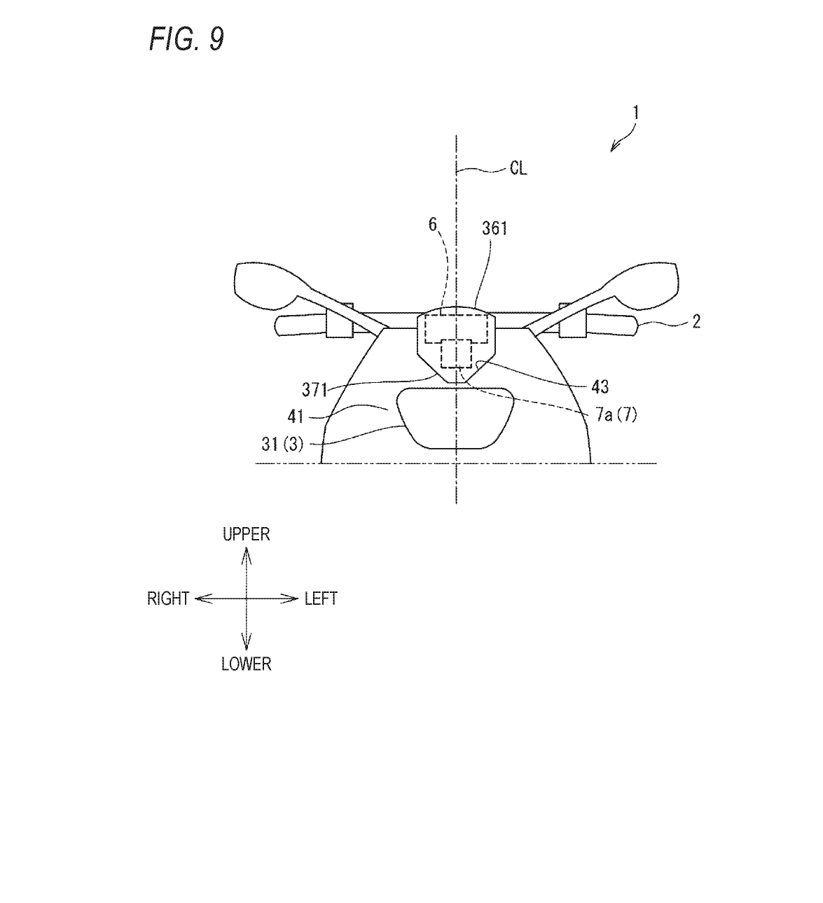

FIG. 9 is a front view showing a motorcycle according to still another modification. The motorcycle 1 according to the still another modification does not include the windshield 5, which is a windshield member, as compared with the motorcycle 1 according to the embodiment. Even in this case, the radar device 7 is covered by a meter visor 361, which is another windshield member. In other words, the transmission-reception surface 7a of the radar device 7 is covered from the front by the meter visor 361.

In the motorcycle 1 according to the modification, the transmission-reception surface 7a is covered with the meter visor 361 as in the embodiment. In this case, similarly to the embodiment, the radar device 7 is disposed below and adjacent to the rear of the meter visor 361, which is the windshield member 5. Accordingly, the accommodation space S for disposing the radar device 7 can be easily secured, and a decrease in the degree of freedom in design of the front part of the vehicle can be reduced.

As described above, the structure according to the present embodiment can be applied even when a windshield is not provided at the upper end of the bar handle 2. The meter visor 361 may be fixed to the front fork in addition to being fixed to the vehicle body frame. In this case, the radar device 7 adjacent to the lower side and the rear side of the meter visor may also be configured to be angularly displaced from the vehicle body frame in response to a steering operation of the rider. The structure can also be applied to a motorcycle that includes a meter visor and is not provided with a front cowl.

The motorcycle 1 according to the present embodiment has the following effects.

A motorcycle 1 according to the present disclosure includes: a front cowl 41 that forms an outer shell of the motorcycle 1; a windshield member 5 that is provided on an upper portion of the front cowl 41, that inclines upward from a front end 51 toward a rear side, and that is configured to deflect traveling wind upward; and a radar device 7 that is adjacent to a lower side of the windshield member 5, that has at least a part located rearward of the front end 51 of the windshield member 5, and that is configured to detect an object in front, in which the windshield member 5 includes a radar cover 71 that inclines upward from a front end toward the rear side and that covers the radar device 7 from a front side.

According to the present disclosure, the radar device 7 is disposed below and adjacent to the rear side of the meter visor, which is the windshield member. Accordingly, at least a part of the radar device 7 can be disposed in a space in an upper portion of the vehicle body that is formed for the windshield function. Therefore, the accommodation space S for disposing the radar device 7 can be easily secured, and a decrease in the degree of freedom in design of the front part of the vehicle can be reduced. For example, compared to a case where the entire radar device 7 is disposed inside the front cowl 41, the front cowl 41 can be made smaller more easily. In other words, the vertical dimension of the front cowl 41 can be easily reduced. In this case, the front cowl 41 can be easily formed into a streamlined shape, and it is possible to achieve both a reduction in traveling resistance and the ability to accommodate the radar device 7.

The radar cover 71 is inclined upward from the front end toward the rear side. As a result, the traveling wind that collides with the radar cover 71 from the front side can be guided upward as it travels rearward. This not only protects the radar device, but also provides a windshield effect and reduces traveling resistance using the radar cover.

The radar cover 71 is curved such that a horizontal cross-sectional shape is convex forward.

According to this configuration, the traveling wind can be guided in the left-right direction by the radar cover 71, and the traveling resistance can be reduced. Further, by curving the radar cover 71 in an arc shape, the effects of deflection of radar waves due to passing through the radar cover 71 can be reduced as compared to when the curvature is large, and a decrease in the accuracy of detecting objects in front can be prevented.

The headlamp 3 configured to emit light forward is further provided, and a transmission-reception surface 7a of the radar device 7 is disposed above and spaced apart from the headlamp 3.

According to this configuration, the radar device 7 is disposed above and spaced apart from the headlamp 3, so that interference of the headlamp 3 with respect to the radar irradiation can be prevented.

The transmission-reception surface 7a of the radar device 7 is disposed above and spaced apart from the front cowl 41.

According to this configuration, the radar device 7 is disposed above and spaced apart from the front cowl 41, so that the adverse effects of radar waves passing through the front cowl 41 can be reduced and a decrease in the accuracy of detecting objects in front can be prevented. Further, compared to a case where the radar device 7 is disposed inside the front cowl 41, the degree of freedom in designing the front cowl 41 can be increased.

The front cowl 41 has a cowl recessed portion 43 formed by cutting an upper portion of a central portion in a width direction downward, and the radar cover 71 is disposed in the cowl recessed portion 43 of the front cowl 41 and bulges upward from the recessed portion.

This makes it easy to form the accommodation space for accommodating the radar device 7 using the radar cover 71 while preventing an increase in the dimension of the front cowl 41 in the upper-lower direction.

The headlamp 3 configured to emit light forward is further provided, and a part of the front cowl 41 is interposed between the radar cover 71 and the headlamp 3 in the front-rear direction.

According to this configuration, the radar device 7 can be disposed farther away from the headlamp 3, which makes it easier to increase the degree of freedom in designing the portion below the radar device 7.

A curvature of a horizontal cross section of a front end of the radar cover 71 is larger than a curvature of a horizontal cross section of a rear end of the radar cover 71.

According to this configuration, the curvature of the radar cover 71 increases toward the front end, making it easier to smoothly guide the traveling wind from the front end side toward the rear end side.

The radar cover 71 is implemented by the meter visor 61 that covers the display device 6 from the front side.

According to this configuration, the radar cover 71 can be used as the meter visor 61 as well.

The windshield member 5 includes a windshield 5 made of a transparent material, and the windshield 5 is disposed to avoid a transmission-reception surface 7a of the radar device 7 in a front view.

According to this configuration, it is possible to prevent interference with radar irradiation caused by the windshield 5 being disposed in front of the radar device 7.

The windshield 5 has a portion that covers the radar cover 71 from the front side in a region avoiding the transmission-reception surface 7a of the radar device 7 in a front view.

According to this configuration, a region of the windshield 5 that receives the traveling wind can be increased, and the windshield effect can be enhanced.

The motorcycle 1 is a vehicle in which a rider straddles a seat S1 while riding, and a foot rest portion where the rider places the feet while riding may be located outside the seat S1 in the width direction or may be located in front of the seat S1. The power source for propelling the motorcycle 1 may be an internal combustion engine, an electric motor, or a hybrid power source that uses both an internal combustion engine and an electric motor.

The vehicle according to the present embodiment can be suitably used in vehicles in which a part of the riding space is open to the outside in the traveling state and which is provided with a windshield member that deflects upward the traveling wind that is directed toward the rider from the front, thereby preventing the traveling wind from colliding with the rider. For example, the structure according to the present embodiment may be applied to a small planing boat or an all-terrain vehicle (ATV) in addition to the straddle-type vehicle. The vehicle to which this embodiment is applied is preferably a straddle-type vehicle with a relatively small dimension in the vehicle width direction and a single seat or seats arranged in front and behind.

As another example, the headlamp may be a multi-lens type with two lenses. As another example, a left portion and a right portion of the headlamp may be spaced apart in the width direction. In this case, when the left and right portions are combined to form a headlamp unit, the center position in the width direction of the headlamp unit is located at the center position in the vehicle width direction of the vehicle. In other words, the headlamp unit is disposed at the center of the vehicle body in the width direction at an interval. The headlamp may also incorporate other lighting devices such as a turn signal and a position lamp.

In the present embodiment, the headlamp is supported by the vehicle body frame. Alternatively, it may be supported by a front fork as another example. In this case, the headlamp undergoes angular displacement together with the front fork relative to the vehicle body in response to the steering operation. The radar layout of this embodiment may be implemented even in such a headlamp.

In the present embodiment, a configuration in which the meter visor 61 and the radar cover 71 are integrated has been described, but the present disclosure is not limited thereto, and the meter visor 61 and the radar cover 71 may be separate bodies. In this case, it is preferable that the radar cover, which is separate from the meter visor, has a windshield function for reducing traveling wind blowing toward the rider. The radar device may be disposed in a space directly below the windshield member. In other words, the radar device may or may not be in contact with the windshield member.

In the present embodiment, the third inclination angle α3, which is the angle of the radar cover, is larger than the second inclination angle α2, which is the angle of the front cowl, but the present disclosure is not limited thereto. The third inclination angle α3 may be the same as the second inclination angle α2, for example, the front cowl and the radar cover may be formed to be flush with each other. The third inclination angle α3 may be smaller than the second inclination angle α2. Further, in the vertical cross section, the upper end of the front cowl and the lower end of the radar cover may be disposed to be offset in the upper-lower direction. For example, the lower end of the radar cover may be disposed rearward of the upper end of the front cowl. Further, although the radar cover is made of a material different from that of the remaining portion of the meter visor and is made of a material with high radar transparency, the present invention is not limited thereto. The radar cover may be made of the same material as the remaining portion of the meter visor.

The straddle-type vehicle according to the present disclosure is not limited to the configuration of the above-described embodiment, and various modifications may be made.

### Appendix

The present disclosure includes the following aspects.

### Aspect 1

A vehicle includes:
a front cowl that forms an outer shell of the vehicle;
a windshield member that is provided on an upper portion of the front cowl, that inclines upward from a front end toward a rear side, and that is configured to deflect traveling wind upward; and
a radar device that is adjacent to a lower side of the windshield member, that has at least a part located rearward of the front end of the windshield member, and that is configured to detect an object in front,
in which the windshield member includes a radar cover that inclines upward from a front end toward the rear side and that covers the radar device from a front side.

### Aspect 2

In the vehicle according to Aspect 1, the radar cover is curved such that a horizontal cross-sectional shape is convex forward.

### Aspect 3

The vehicle according to Aspect 1 or 2, further includes:
a headlamp configured to emit light forward,
in which a transmission-reception surface of the radar device is disposed above and spaced apart from the headlamp.

### Aspect 4

In the vehicle according to any one of Aspects 1 to 3, a transmission-reception surface of the radar device is disposed above and spaced apart from the front cowl.

### Aspect 5

In the vehicle according to Aspect 3,
the front cowl is inclined upward from a front end toward the rear side, and has a recessed portion formed by cutting an upper portion of a central portion in a width direction downward, and
the radar cover is disposed in the recessed portion of the front cowl and bulges upward from the recessed portion.

### Aspect 6

The vehicle according to any one of Aspects 3 to 5, further includes:
a headlamp configured to emit light forward,
in which the front cowl covers a portion of the headlamp from the front side except for an illumination region, and is inclined upward from a front end toward the rear side, and
a part of the front cowl is interposed between the radar cover and the headlamp in a front-rear direction.

### Aspect 7

In the vehicle according to any one of Aspects 1 to 6, a curvature of a horizontal cross section of a front end of the radar cover is larger than a curvature of a horizontal cross section of a rear end of the radar cover.

### Aspect 8

In the vehicle according to any one of Aspects 1 to 7, the radar cover is implemented by a meter visor that covers a display device from the front side.

### Aspect 9

In the vehicle according to any one of Aspects 1 to 8, the windshield member includes a windshield made of a transparent material, and the windshield is disposed to avoid a transmission-reception surface of the radar device in a front view.

### Aspect 10

In the vehicle according to any one of Aspects 1 to 8, the windshield member includes a windshield made of a transparent material, and the windshield has a portion that covers the radar cover from the front side in a region avoiding a transmission-reception surface of the radar device in a front view.

### Aspect 11

In the vehicle according to any one of Aspects 1 to 10, the radar cover is implemented by a part of a windshield made of a transparent material.

### Aspect 12

A vehicle includes:
a meter visor that is inclined upward from a front end toward a rear side, and that is configured to deflect traveling wind upward and cover a display device from a front side; and
a radar device that is adjacent to a lower side of the meter visor, that has at least a part located rearward of the front end of the meter visor, and that is configured to detect an object in front,
in which the meter visor includes a radar cover that is inclined upward from a front end toward the rear side and that covers the radar device from the front side.

What is claimed is:

1. A vehicle comprising:
a front cowl configured as an outer shell of the vehicle;
a windshield member provided on an upper portion of the front cowl, inclining upward from a front end toward a rear side, and configured to deflect traveling wind upward; and
a radar device adjacent to a lower side of the windshield member, having at least a part located rearward of the front end of the windshield member, and configured to detect an object in front, wherein
the windshield member includes a radar cover inclining upward from a front end toward the rear side to cover the radar device from a front side.

2. The vehicle according to claim 1, wherein
the radar cover is curved such that a horizontal cross-sectional shape is convex forward.

3. The vehicle according to claim 1, further comprising:
a headlamp configured to emit light forward, wherein
a transmission-reception surface of the radar device is disposed above and spaced apart from the headlamp.

4. The vehicle according to claim 1, wherein
a transmission-reception surface of the radar device is disposed above and spaced apart from the front cowl.

5. The vehicle according to claim 1, wherein
the front cowl is inclined upward from a front end toward the rear side, and has a recessed portion concave downward at an upper portion of a central portion in a width direction, and
the radar cover is disposed in the recessed portion of the front cowl and is shaped to bulge upward from the recessed portion.

6. The vehicle according to claim 1, further comprising:
a headlamp configured to emit light forward, wherein
the front cowl covers a portion of the headlamp from the front side except for an illumination region, and is inclined upward from a front end toward the rear side, and
a part of the front cowl is interposed between the radar cover and the headlamp in a front-rear direction.

7. The vehicle according to claim 1, wherein
a curvature of a horizontal cross section of a front end of the radar cover is larger than a curvature of a horizontal cross section of a rear end of the radar cover.

8. The vehicle according to claim 1, wherein
the radar cover is implemented by a meter visor that covers a display device from the front side.

9. The vehicle according to claim 1, wherein
the windshield member includes a windshield made of a transparent material, and the windshield is disposed to avoid a transmission-reception surface of the radar device in a front view.

10. The vehicle according to claim 1, wherein
the windshield member includes a windshield made of a transparent material, and
the windshield has a portion that covers the radar cover from the front side in a region avoiding a transmission-reception surface of the radar device in a front view.

11. The vehicle according to claim 1, wherein
the radar cover is implemented by a part of a windshield made of a transparent material.

12. A vehicle comprising:
a meter visor inclined upward from a front end toward a rear side, configured to deflect traveling wind upward, and covering a display device from a front side; and
a radar device adjacent to a lower side of the meter visor, having at least a part located rearward of a front end of the meter visor, and configured to detect an object in front, wherein
the meter visor includes a radar cover inclining upward from a front end toward the rear side to cover the radar device from the front side.
